(19) United States
(12) Patent Application Publication
(10) Pub. No.: US 2007/0271060 A1
(43) Pub. Date: Nov. 22, 2007

(54) Buffer compensation activation

(76) Inventor: Terry Fletcher, Rancho Cordova, CA (US)

Correspondence Address: Caven & Aghevli LLC;c/o PortfolioIP, P.O. Box 52050, Minneapolis, MN, 55402, US

(21) Appl. No.: 11/438,406

(22) Filed: May 22, 2006

(51) Int. Cl. G06F 19/00; G01K 17/00

(52) U.S. Cl. 702/132; 702/85; 702/107; 702/127; 702/130

(57) ABSTRACT

In some embodiments, an apparatus comprises a thermal sensor to detect a first temperature reading at a location proximate a buffer circuit at a first point in time and to detect a second temperature reading at a location proximate a buffer circuit at a second point in time, logic to generate a buffer compensation activation signal when the second temperature reading differs from the first temperature reading by an amount exceeding a threshold, and logic to transmit the buffer compensation activation signal to a buffer compensation module. Other embodiments are described.

### BACKGROUND

The subject matter described herein relates generally to the field of integrated circuits and more particularly to systems and methods for buffer compensation activation.

Computer systems typically include a number of integrated circuits such as, e.g., a processor, one or more memory devices, and one or more input-output or I/O devices. The various integrated circuits communicate through one or more bus structures. A bus may include a set of control lines and a set of data lines. The control lines carry signals representing requests and acknowledgments and signals to indicate what type of data is on the data lines. The data lines carry data, complex commands, or addresses. Communication over the bus structure may be managed by a protocol, which is a set of rules governing communication over the bus that are implemented and enforced by a device that is appointed a bus master.

Communication signals may be exchanged between a sender and a receiver over a bus. The sender may include a driver, such as an output buffer, connected to each bus line to which it sends signals. The receiver may include an input buffer connected to each bus line from which it receives signals. When the sender transmits a signal on a particular line, the sender directs the appropriate output buffer to bring the line to a suitable voltage, e.g., either high or low. The receiver detects the signal voltage to complete the communication. The signal may be reflected at the receiver if an impedance of the output buffer is different from a characteristic impedance of the line. Signal reflection slows the operation of the bus and the computer system.

Signal reflection in high speed bus structures may be reduced by matching, to the extent possible, the impedance of devices connected to the bus lines with the characteristic impedance of the bus lines. One technique of reducing reflection on a bus line is to damp or dissipate signal reflections with a termination in an output buffer connected to the bus line. A termination is a dissipating or damping load, e.g., a resistive device, the impedance of which matches the impedance of the line, thereby reducing a difference between the impedance of the output buffer and the characteristic impedance of the line.

Signal transfer performance also may be improved by establishing a substantially uniform slew rate in the output buffers connected to the bus lines. The slew rate refers to the rate of change of voltage (i.e., voltage change/time) that an output buffer can generate at a terminal on a bus line when the output buffer is changing a signal state on the bus line. The slew rate may be referred to as a rise time (i.e., low to high) or a fall time (i.e., high to low) of the signal. A slew rate may be selected for the bus, and the output buffers connected to the bus may then be selected to have a substantially similar slew rate to support high speed signal transfer on the bus.

Selecting output buffers may be difficult because the output impedance and the slew rate of an output buffer can each change due to variations in process, supply voltage, and temperature. Fabrication process parameters can affect the slew rate of an output buffer as well, as the resistance of transistors or resistors in the output buffer. In addition, an integrated circuit will operate more slowly with a low supply voltage and at a high temperature. Conversely, a high supply voltage and a low temperature will cause the chip to operate more rapidly.

Buffers may be impedance compensated to address problems associated with the changes in operating conditions such as process, voltage and temperature. Impedance compensated input/output buffers address the problems associated with varying conditions by providing mechanisms to help maintain characteristics of input/output buffer drivers over a wide range of operating conditions.

### BRIEF DESCRIPTION OF THE DRAWINGS

The detailed description is provided with reference to the accompanying figures. In the figures, the left-most digit(s) of a reference number may identify the figure in which the reference number first appears. The use of the same reference numbers in different figures may indicate similar or identical items.

FIG. 1 is a schematic illustration of an exemplary computing device adapted to perform buffer compensation activation operations in accordance with some embodiments.

FIG. 2 is a schematic illustration of an integrated circuit device adapted to perform buffer compensation activation operations in accordance with some embodiments.

FIG. 3 is a flowchart illustrating buffer compensation activation operations that may be performed by the systems of FIG. 1 and FIG. 2 in accordance with some embodiments.

FIG. 4 is a schematic illustration of a computing device in accordance with some embodiments.

### DETAILED DESCRIPTION

Described herein are exemplary systems and methods for buffer compensation activation in integrated circuit devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

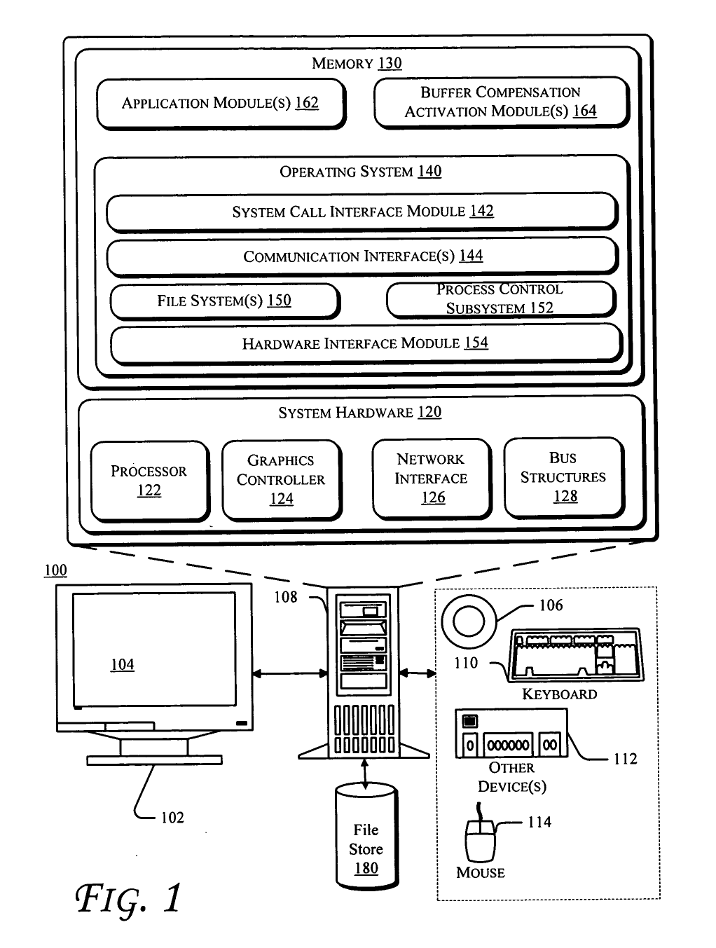

FIG. 1 is a schematic illustration of a computing system 100 adapted to perform buffer compensation activation operations according to some embodiments. In some embodiments, system 100 includes a computing device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

The computing device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, video controllers 124, network interfaces 126, and bus structures 128. In some embodiments, processor 122 may be embodied as an Intel® Pentium IV® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics controller 124 may function as an adjunction processor that manages graphics and/or video operations. Graphics controller 124 may be integrated onto the motherboard of computing system 100 or may be coupled via an expansion slot on the motherboard.

In some embodiments, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In some embodiments, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In some embodiments, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments, the computing device 108 may be embodied as a personal computer, a laptop computer, a personal digital assistant, a mobile telephone, an entertainment device, or another computing device.

In some embodiments, memory 130 includes one or more application modules 162 to execute one or more applications on computing system 100. Memory 130 may further include a buffer compensation activation module 162 to generate a buffer compensation activation signal when one or more environmental variables in the computing system change by a threshold amount. In some embodiments, the buffer compensation activation module 164 generates and transmits a buffer compensation activation signal to a buffer compensation module when a temperature reading changes by a threshold value.

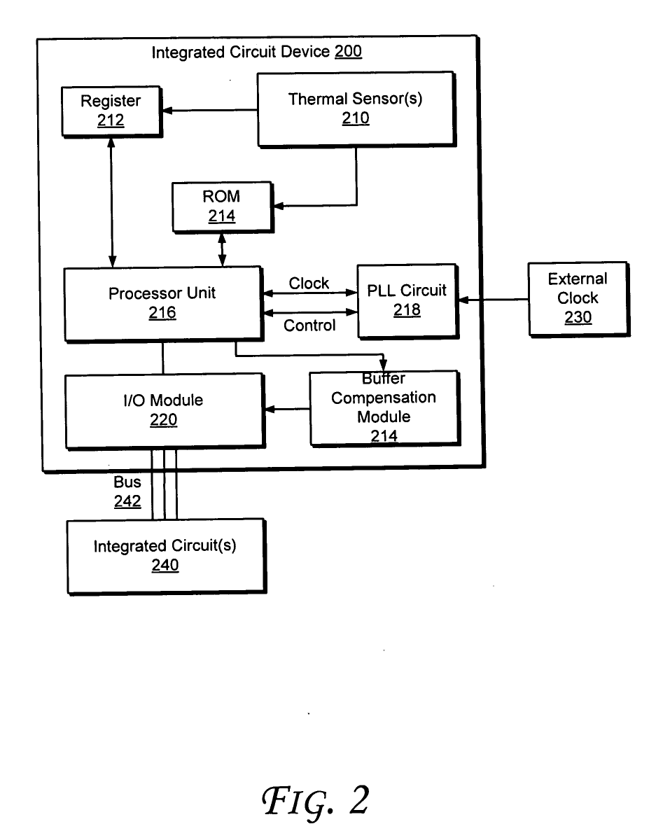

FIG. 2 is a schematic illustration of an integrated circuit device 200 adapted to perform buffer compensation activation operations in accordance with some embodiments. In some embodiments, FIG. 2 may be one component of a computing system 100 depicted in FIG. 1. In some embodiments, integrated circuit device 200 may be implemented as a microprocessor.

Referring to FIG. 2, integrated includes one or more thermal sensors 210 to detect temperature readings proximate the integrated circuit device. In some embodiments, thermal sensor(s) may be implemented as one or more thermocouples incorporated into the die of the integrated circuit device. The thermal sensor(s) may be located physically proximate one or more input/output (I/O) buffers on integrated circuit device 200. Integrated circuit device 200 may further include a register 212 coupled to thermal sensor(s) 210 and a memory module such as a random operational memory (ROM) 214, which also may be coupled to thermal sensor(s) 210.

Integrated circuit device 200 may further include a processor unit 216 coupled to register 212 and to ROM 214. Processor unit 216 is intended to present a broad category of microprocessor circuits comprising a wide range of microprocessor functions. Processor 216 may be embodied as an Intel® Pentium IV® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Processor 216 may be coupled to a phase lock loop (PLL) circuit 218, which in turn may be coupled to an external clock 230. External clock 230 provides a clock signal to the PLL circuit 218. The PLL circuit 218 permits fine tuning and variable frequency adjustment of the input clock signal. Specifically, the PLL circuit 218 receives a value, and increases or decreases the frequency based on the value received. The PLL circuit 218 is intended to represent a broad category of frequency adjustment circuits, which are well known in the art and will not be described further. The output of the PLL circuit 218 may correspond to the microprocessor system clock, which may be input to the processor unit 216.

Integrated circuit device 200 may further include one or more input/output (I/O) modules 220 coupled to processor unit 216. I/O module 220 may be coupled to one or more integrated circuits 240 via a communication bus 242. As described above, I/O module may include one or more input/output buffers to facilitate communication over bus 242. Integrated circuit device 200 may further include a buffer compensation module 214 coupled to processor unit 216 and to I/O module 220. In some embodiments, buffer compensation module 214 may include a buffer compensation circuit and logic block that adjusts the slew rate and/or the impedance value of one or more buffers in I/O module 220.

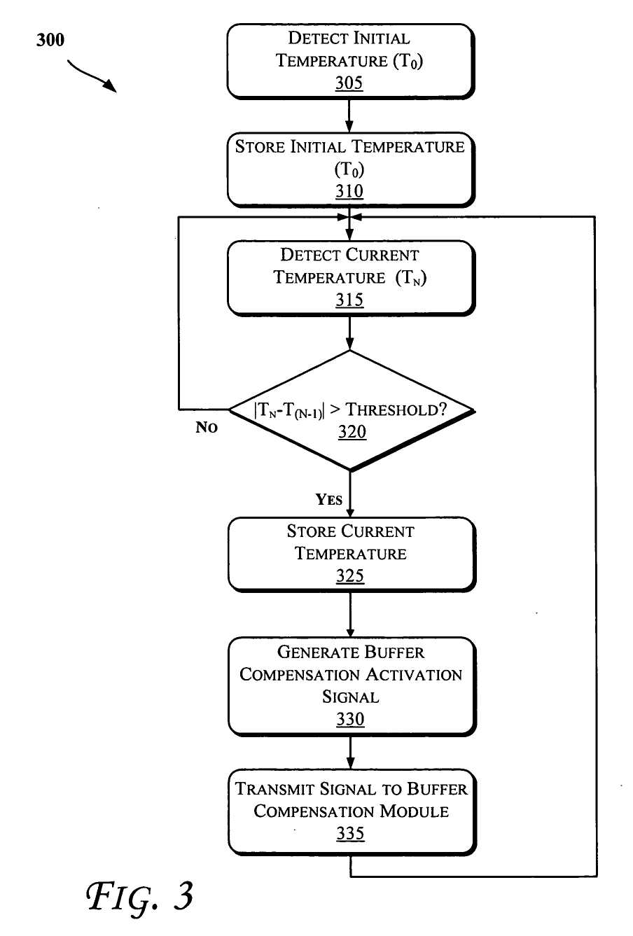

FIG. 3 is a flowchart illustrating buffer compensation activation operations that may be performed by the systems of FIG. 1 and FIG. 2 in accordance with some embodiments. In some embodiments, the operations of FIG. 3 may be implemented as logic instructions stored on a computer-readable medium such as, e.g., the memory 130 of computer system 100 depicted in FIG. 1, or in the ROM 214 of the integrated circuit device 200 depicted in FIG. 2. The logic instructions, when executed by a processor such as the processor 122 or processor unit 216, configure the processor to perform the operations described in FIG. 3. Hence, the memory modules and processor constitute structure for performing the operations. In some embodiments the logic instructions may be configured into a programmable device such as, for example, a field programmable gate array (FPGA), or reduced to hard-wired logic circuitry.

Referring to FIG. 3, at operation 305 an initial temperature reading is detected, and at operation 310 the temperature reading may be stored in a memory location. In some embodiments, a reading from thermal sensor(s) 210 may be stored in register 310. In practice, thermal sensor 210 may generate a signal directly indicative of a temperature proximate a buffer circuit. Alternatively, thermal sensor(s) 210 may generate a signal such, as e.g., a voltage value that is representative of a temperature.

At operation 315 a current temperature is detected. In some embodiments, the current temperature may be detected by the same thermal sensor(s) used to obtain the initial temperature reading. In some embodiments the current temperature may be obtained by a different thermal sensor(s) 210.

If, at operation 320, a difference between the current temperature reading (T_{N}) and the previous temperature at the time of the prior buffer compensation (T_{N-1}) does not exceed a threshold, then no buffer compensation is performed. Control then passes back to operation 315 and a new current temperature is detected from thermal sensor(s) 210. In some embodiments, the threshold may be determined as a design parameter by a manufacturer of an integrated circuit device. The threshold may represent a temperature value, or a temperature rate-of-change value.

By contrast, if at operation 320 the different between the current temperature (T_{N}) and the previous temperature (T_{N-1}) exceeds a threshold, then control passes to operation 325 and the current temperature reading is stored in a suitable memory module as the new T_{N-1}. Control then passes to operation 330 and a buffer compensation activation signal is generated. In some embodiments, the buffer compensation signal may include information such as, e.g., the previous temperature, the current temperature, and the temperature difference. In some embodiments, the buffer compensation signal may omit additional information. At operation 335 the buffer compensation activation signal is transmitted to the buffer compensation module 214. In response, buffer compensation module may implement a buffer compensation routine to modify operating parameters such as, e.g., the slew rate and/or the impedance of one or more I/O buffers proximate thermal sensor(s) 210. Control then may pass back to operation 315.

Thus, the operations of FIG. 3 provide a control loop which monitors temperature readings proximate one or more I/O buffers and generates a buffer compensation activation signal when a change in temperature exceeds a threshold. The control loop may be activated when power is supplied to the integrated circuit device 200.

In some embodiments, the control loop may also monitor voltage parameters in the I/O buffers and may generate a buffer compensation activation signal when a change in voltage exceeds a threshold.

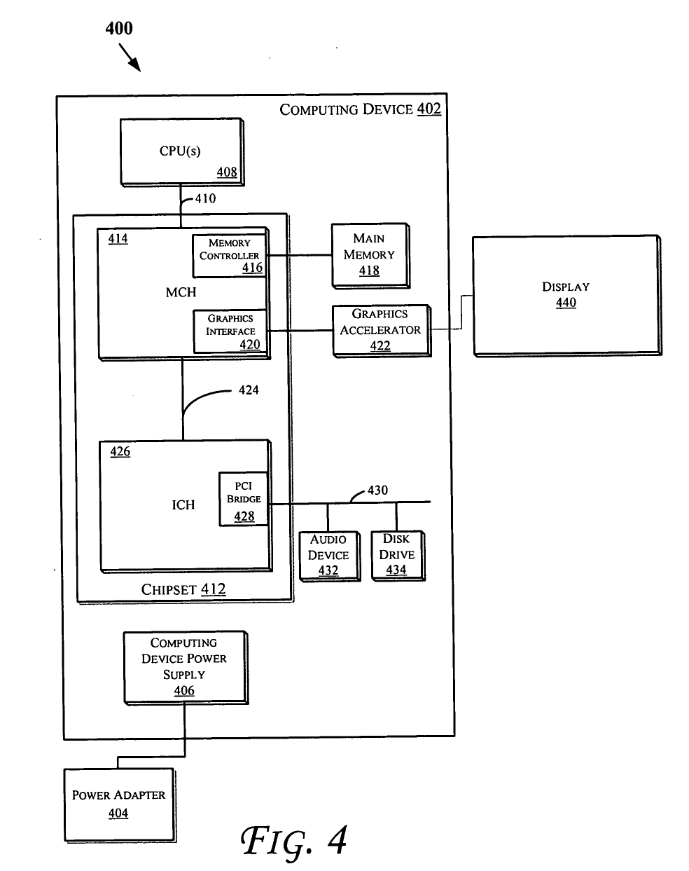

FIG. 4 is a schematic illustration of a computer system 400 in accordance with some embodiments. The computer system 400 includes a computing device 402 and a power adapter 404 (e.g., to supply electrical power to the computing device 402). The computing device 402 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 402 (e.g., through a computing device power supply 406) from one or more of the following sources: one or more battery packs, an alternating current (AC) outlet (e.g., through a transformer and/or adaptor such as a power adapter 404), automotive power supplies, airplane power supplies, and the like. In some embodiments, the power adapter 404 may transform the power supply source output (e.g., the AC outlet voltage of about 110VAC to 240VAC) to a direct current (DC) voltage ranging between about 7VDC to 12.6VDC. Accordingly, the power adapter 404 may be an AC/DC adapter.

The computing device 402 may also include one or more central processing unit(s) (CPUs) 408 coupled to a bus 410. In some embodiments, the CPU 408 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 412 may be coupled to the bus 410. The chipset 412 may include a memory control hub (MCH) 414. The MCH 414 may include a memory controller 416 that is coupled to a main system memory 418. The main system memory 418 stores data and sequences of instructions that are executed by the CPU 408, or any other device included in the system 400. In some embodiments, the main system memory 418 includes random access memory (RAM); however, the main system memory 418 may be implemented using other memory types such as dynamic RAM (DRAM), synchronous DRAM (SDRAM), and the like. Additional devices may also be coupled to the bus 410, such as multiple CPUs and/or multiple system memories.

The MCH 414 may also include a graphics interface 420 coupled to a graphics accelerator 422. In some embodiments, the graphics interface 420 is coupled to the graphics accelerator 422 via an accelerated graphics port (AGP). In some embodiments, a display (such as a flat panel display) 440 may be coupled to the graphics interface 420 through, for example, a signal converter that translates a digital representation of an image stored in a storage device such as video memory or system memory into display signals that are interpreted and displayed by the display. The display 440 signals produced by the display device may pass through various control devices before being interpreted by and subsequently displayed on the display.

A hub interface 424 couples the MCH 414 to an input/output control hub (ICH) 426. The ICH 426 provides an interface to input/output (I/O) devices coupled to the computer system 400. The ICH 426 may be coupled to a peripheral component interconnect (PCI) bus. Hence, the ICH 426 includes a PCI bridge 428 that provides an interface to a PCI bus 430. The PCI bridge 428 provides a data path between the CPU 408 and peripheral devices. Additionally, other types of I/O interconnect topologies may be utilized such as the PCI Express™ architecture, available through Intel® Corporation of Santa Clara, Calif.

The PCI bus 430 may be coupled to an audio device 432 and one or more disk drive(s) 434. Other devices may be coupled to the PCI bus 430. In addition, the CPU 408 and the MCH 414 may be combined to form a single chip. Furthermore, the graphics accelerator 422 may be included within the MCH 414 in some embodiments. As yet another alternative, the MCH 414 and ICH 426 may be integrated into a single component, along with a graphics interface 420.

Additionally, other peripherals coupled to the ICH 426 may include, in some embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 402 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “some embodiments” means that a particular feature, structure, or characteristic described in connection with the embodiment is included in at least an implementation. The appearances of the phrase “in some embodiments” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a thermal sensor to detect a first temperature reading at a location proximate a buffer circuit at a first point in time and to detect a second temperature reading at a location proximate a buffer circuit at a second point in time;
logic to generate a buffer compensation activation signal when the second temperature reading differs from the first temperature reading by an amount exceeding a threshold; and
logic to transmit the buffer compensation activation signal to a buffer compensation module.

2. The apparatus of claim 1, further comprising a memory module to store the first temperature reading and the second temperature reading.

3. The apparatus of claim 1, wherein the thermal sensor detects a temperature reading at a location on an integrated circuit.

4. The apparatus of claim 1, wherein:
the apparatus comprises a microprocessor;
the thermal sensor comprises a thermocouple on the microprocessor; and
the memory module comprises a register coupled to the thermocouple to receive a temperature reading from the thermocouple.

5. The apparatus of claim 3, wherein:
the apparatus further comprises an operational memory; and
the logic to generate a buffer compensation activation signal when the second temperature reading differs from the first temperature reading by an amount exceeding a threshold resides in the operational memory.

6. The apparatus of claim 1, wherein the buffer compensation module activates a buffer compensation routine in response to the buffer compensation activation signal.

7. A system comprising:
a storage device;
one or more bus structures coupled to one or more integrated circuit devices, wherein the one or more integrated circuit devices include at least one processor;
a thermal sensor to detect a first temperature reading at a location proximate a buffer circuit on one of the integrated circuit devices at a first point in time and to detect a second temperature reading at a location proximate a buffer circuit at a second point in time;
a compensation activation module comprising logic instructions stored on a computer-readable medium which, when executed, configures the processor to:
generate a buffer compensation activation signal when the second temperature reading differs from the first temperature reading by an amount exceeding a threshold; and
transmit the buffer compensation activation signal to a buffer compensation module.

8. The system of claim 7, further comprising a memory module to store the first temperature reading and the second temperature reading.

9. The system of claim 7, wherein the thermal sensor detects a temperature reading at a location on an integrated circuit device.

10. The system of claim 7, wherein:
the thermal sensor comprises a thermocouple on the microprocessor; and
the memory module comprises a register coupled to the thermocouple to receive a temperature reading from the thermocouple.

11. The system of claim 7, wherein the buffer compensation module activates a buffer compensation routine in response to the buffer compensation activation signal.

12. A method comprising:
detecting a first temperature reading at a location proximate a buffer circuit;
generating a buffer compensation activation signal when the first temperature reading differs from a second temperature reading by an amount exceeding a threshold; and
transmitting the buffer compensation activation signal to a buffer compensation module.

13. The method of claim 12, wherein detecting a first temperature reading at a location proximate a buffer circuit comprises receiving an input signal from a thermal sensor proximate the buffer circuit.

14. The method of claim 12, wherein generating a buffer compensation activation signal when the temperature differs from a second temperature reading by an amount exceeding a threshold comprises:
retrieving the second temperature reading from a memory location;
comparing the first temperature reading to the second temperature reading; and
generating the buffer compensation activation signal when the difference between the first temperature reading and the second temperature reading exceeds the threshold.

15. The method of claim 12, further comprising storing the first temperature reading in a memory location.

16. The method of claim 12, further comprising:
detecting a third temperature reading at a location proximate a buffer circuit;
generating a buffer compensation activation signal when the third temperature reading differs from the first temperature reading by an amount exceeding a threshold; and
transmitting the buffer compensation activation signal to a buffer compensation module.

17. The method of claim 12, further comprising:
receiving the buffer compensation activation signal in the buffer compensation module; and
compensating one or more attributes of the buffer circuit.

18. A computer program product encoded on a computer readable medium comprising logic instructions which, when executed by a processor, configure the processor to:
detect a first temperature reading at a location proximate a buffer circuit;
generate a buffer compensation activation signal when the first temperature reading differs from a second temperature reading by an amount exceeding a threshold; and
transmit the buffer compensation activation signal to a buffer compensation module.

19. The computer program product of claim 18, further comprising logic instructions which, when executed by a processor, configure the processor to:
retrieve the second temperature reading from a memory location;
compare the first temperature reading to the second temperature reading; and
generate the buffer compensation activation signal when the difference between the first temperature reading and the second temperature reading exceeds the threshold.

20. The computer program product of claim 18, further comprising logic instructions which, when executed by a processor, configure the processor to:
detect a third temperature reading at a location proximate a buffer circuit;
generate a buffer compensation activation signal when the third temperature reading differs from the first temperature reading by an amount exceeding a threshold; and
transmit the buffer compensation activation signal to a buffer compensation module.

21. The computer program product of claim 18, further comprising logic instructions which, when executed by a processor, configure the processor to:
receive the buffer compensation activation signal in the buffer compensation module; and
compensate one or more attributes of the buffer circuit.
